(19) United States
(12) Patent Application Publication
(10) Pub. No.: US 2014/0113615 A1
(43) Pub. Date: Apr. 24, 2014

(54) Remote Controlled Headset with Built-In Cellular/Mobile Telephone Module

(71) Applicant: Alex Yao, Shenzhen (CN)

(72) Inventor: Alex Yao, Shenzhen (CN)

(21) Appl. No.: 14/143,321

(22) Filed: Dec. 30, 2013

Related U.S. Application Data
(63) Continuation-in-part of application No. PCT/EP2012/061095, filed on Jun. 12, 2012.

(30) Foreign Application Priority Data
Jun. 30, 2011 (DK) PA 2011 00489

(51) Int. Cl. H04M 1/60; H04M 1/725

(52) U.S. Cl. CPC H04M 1/6066; H04M 1/7253
USPC 455/418; 455/41.2; 455/569.1

(57) ABSTRACT

A headset for wireless telecommunication comprising a speaker, a microphone, a short-range transceiver for establishing a short-range wireless link to a peripheral electronic device comprising a corresponding short-range transceiver and a user interface. The headset also comprises a long-range transceiver for establishing a long-range wireless link to a Base Transceiver Station, whereby the headset is able to make telephone calls. The headset is adapted to receive instructions from the peripheral electronic device via the short-range transceiver to initiate cellular telephone calls.

### CROSS-REFERENCE TO RELATED APPLICATION

This application is a continuation-in-part of PCT international application number PCT/EP2012/061095, filed 12 Jun. 2012, which claims the benefit of Danish Application number PA 2011 00489 filed 30 Jun. 2011, which hereby are incorporated herein by reference in its entirety.

### TECHNICAL FIELD

The disclosure relates to a headset for wireless telecommunication comprising:
a speaker,
a microphone,
a short-range transceiver for establishing a short-range wireless link to a peripheral electronic device comprising a corresponding short-range transceiver and a user interface,
a long-range transceiver for establishing a long-range wireless link to a Base Transceiver Station in a cellular network, whereby the headset is able to make telephone calls.

### BACKGROUND ART

Communication headsets are becoming more and more widely used. Especially, small Bluetooth headsets used with cellular phones have become increasingly popular over the recent years. They provide the possibility of hands free communication, so that the user can drive his car, use his computer or looking into paper files with both hands during phone calls.

Also, headsets with built-in telephony modules which can be used as stand-alone devices for making cellular telephone calls without a separate telephone are known.

In the recent years so-called tablet computers have become very popular. Wikipedia gives the following definition of a tablet computer: “A tablet computer, or simply tablet, is a complete mobile computer, larger than a mobile phone or personal digital assistant, integrated into a flat touch screen and primarily operated by touching the screen. It often uses an onscreen virtual keyboard or a digital pen rather than a physical keyboard.”

A very popular tablet computer is the iPad® 2, which can communicate with the surroundings by the following wireless technologies: Bluetooth, Wi-Fi and 3G. The cellular 3G network is only used for Internet access and not for mobile phone calls.

The term “short-range wireless communication network” comprises WPAN's (wireless personal area networks) and WLAN's (wireless local area networks) while “long-range wireless communication network” refers to mobile telephone networks and wireless WAN's (wireless wide area networks). Examples of short-range wireless communication standards are Bluetooth™ and IEEE 802.11g (a WLAN standard). Examples of long-range wireless communication standards are the mobile telephone standards GSM (Global System for Mobile Communications), 3G/UMTS (Universal Mobile Telecommunications System) and CDMA2000. A telecommunication device connected to a wireless network according to these standards uses a high transmitting power during establishment of a call.

The maximum transmitting power of Bluetooth transceivers is 100 mW for Class 1, 2.5 mW for class 2 and 1 mW for class 3 transceivers. The range for these classes are approximate 100 meters for class 1, approximate 10 meters for class 2 and approximate 5 meters for class 3.

The transmission power in GSM mobile phones is limited to a maximum of 2 watts in GSM850/900 and 1 watt in GSM1800/1900.

US Publication No. 2010/0245585 discloses a wireless headset device which can connect directly to the cellular network.

Due to its size, a headset is normally equipped with a limited user interface, which makes call handling cumbersome, especially if the user interface is used while the headset is worn on the head.

### DISCLOSURE OF INVENTION

An object of the disclosure is to provide a headset which is adapted to connect directly to a cellular telephone network and which is easy to use.

According to the disclosure, the object is obtained by a headset according to the preamble, which is characterised in that the headset is adapted to receive instructions from the peripheral electronic device via the short-range transceiver to initiate cellular telephone calls. Thus, a telephone call can be initiated by means of the user interface of the peripheral electronic device. This user interface can be a keyboard or keypad of a computer, such as laptop computer, or the touchpad of a tablet computer.

The instructions received from the peripheral electronic device can include the identity, such as the phone number, of the party to be called.

The headset may also be adapted to receive telephone calls.

The long-range transceiver of the headset may be adapted to initiate telephone calls via the GSM, UMTS or CDMA cellular networks.

Preferably, the short-range transceiver is a Bluetooth transceiver, as this is radio technology widely used today by electronic devices.

Alternatively, the short-range transceiver is a Wi-Fi transceiver or a cell phone. Because the power requirements for reaching the transceiver may be high, the headset may include wireless recharging capabilities, such as inductive charging, WiPower® or other yet to be developed means.

The headset is preferably adapted for transmitting and receiving voice signals via the short-range-transceiver. Thus, it can be used for hands free communication via another telephone, such as a mobile phone, or it can be used for listening to audio, such as music, from a computer, mobile phone or other device.

The headset according to this disclosure can be a monaural headset with means for attaching it in front of an ear of a user. These means can be an ear hook, an ear loop or just an ear bud for insertion into the ear.

The disclosure also relates to headset system comprising a headset and a peripheral electronic device comprising a short-range transceiver corresponding to the short-range transceiver of the headset and a user interface.

The peripheral electronic device of the headset system may be a tablet computer.

An application for initiating and receiving cellular telephone calls by the headset is preferably installed on the tablet computer. This tablet computer may be an IPad® 2 with an installed “app” (application), which is adapted for handling telephone calls made and received by the headset.

The headset may comprise a contact list with identities and phone numbers of contact persons, which contact list is accessible by the peripheral electronic device. The peripheral electronic device may also comprise a contact list with identities and phone numbers of contact persons. Thus, the user may scroll or search the contact list on a display of the peripheral electronic device. The accessibility may be provided in different ways. The device keeps a synchronised version in its memory and updates the list frequently or on the request by the user. Alternatively, data is exchanged currently during use.

Also, call lists may be updated and synchronized between the headset and the peripheral electronic device.

The disclosure also relates to a method of initiating a cellular telephony call by means of a headset for wireless telecommunication comprising:
a speaker,
a microphone,
a short-range transceiver for establishing a short-range wireless link to a peripheral electronic device comprising a corresponding short-range transceiver and a user interface,
a long-range transceiver for establishing a long-range wireless link to a Base Transceiver Station in a cellular network, whereby the headset is able to make telephone calls,
   whereby the user by means of a user interface of the peripheral electronic device forces the peripheral electronic device to send instructions via the short-range transceiver to the headset to initiate a cellular telephone call.

### BRIEF DESCRIPTION OF THE DRAWINGS

The disclosure is explained in detail below with reference to the drawing illustrating a preferred embodiment of the disclosure in which

FIG. 1 is a schematic disclosure of a headset according to the disclosure in a system where it is used for telecommunication,

FIG. 2 is a diagram disclosing the most relevant elements of a headset system according to an embodiment comprising a headset and a tablet computer, and

FIG. 3 is a flow chart disclosing how to exercise a method according to the disclosure.

### MODES FOR CARRYING OUT THE DISCLOSURE

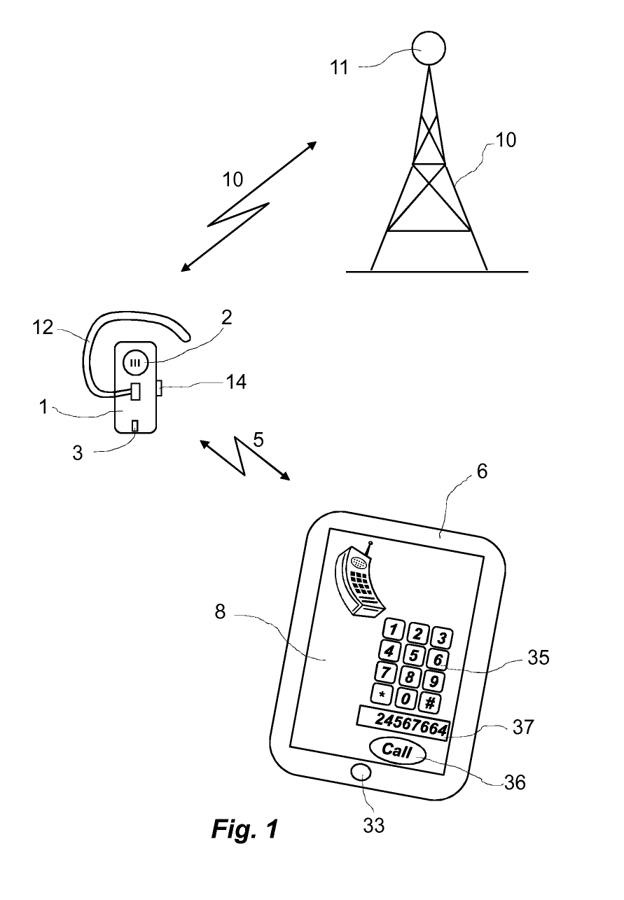

FIG. 1 discloses a scenario comprising a headset 1, a tablet computer 6 and a Base Transceiver Station 11. The headset can be of any known type and typically includes a housing. For further disclosure of headsets, the following patent applications are hereby incorporated by reference: US Publication Nos. 20130243217, 20130183901; 20130114825; 20120082334 as well as other patents and patent applications assigned to GN Netcom, or Jabra. The Base Transceiver Station 11 comprises a mast 34, which is often referred to as a mobile phone mast. The Base Transceiver Station 11 can also be arranged on top of a building or on a high wall and creates a cell site in a cellular mobile phone network. There are different digital cellular technologies, including GSM (Global System for Mobile Communications), GPRS (General Packet Radio Service), CDMA (Code Division Multiple Access), EV-DO (Evolution-Data Optimized), EDGE (Enhanced Data Rates for GSM Evolution), 3GSM and Integrated Digital Enhanced Network (iDEN). In the following description, GSM is chosen as an example, as it is one of the most widespread cellular technologies.

The headset 1 looks like a traditional Bluetooth headset used with mobile phones and comprises an ear hook 12 for attaching the headset 1 to the ear of a user, a speaker 2, a microphone 3 and a multifunction button 14. The headset 1 comprises a GSM transceiver like normal GSM mobile phones, whereby it can be used as a stand-alone device for making and receiving phone calls via the cellular network. Furthermore, the headset 1 comprises a Bluetooth transceiver so that it can establish a short-range Bluetooth link 5 with the tablet computer 6, which also comprises a Bluetooth transceiver. The tablet computer 6 is a flat portable device inter alia comprising a multifunction button 33 and a touchscreen 8 as user interface. A headset phone “app” (abbreviation for application) is installed on the tablet computer 6 making it possible to manage outgoing and incoming phone calls from and to the headset 1. Thus, when the app is active and in use, the touch screen 8 discloses a keypad 35 for entering a phone number, a window 37 showing the number to be dialed and a call button 36. Thus, when a user wants to make a call, he enters the number via the keypad 35 and presses the call button 36. An instruction to dial the entered number is sent via the Bluetooth link 5 to the headset 1, which initiates the call. In this way, the tablet computer 6 provides a convenient user interface for managing calls and the user does not have to take the headset 1 off and/or fumble with the small headset button 14. Contact lists and call lists may also be shown on the touch screen 8 and these lists may be synchronised between the headset 1 and the tablet computer 6 in different ways. In particular, a call list added via a cell phone, computer or tablet, can be configured to constantly update a parallel list in the headset. Thus when the headset connects to a different device, such as a different tablet, it will then make its list available to that device. Simultaneously, the list may be stored on a server in the cloud.

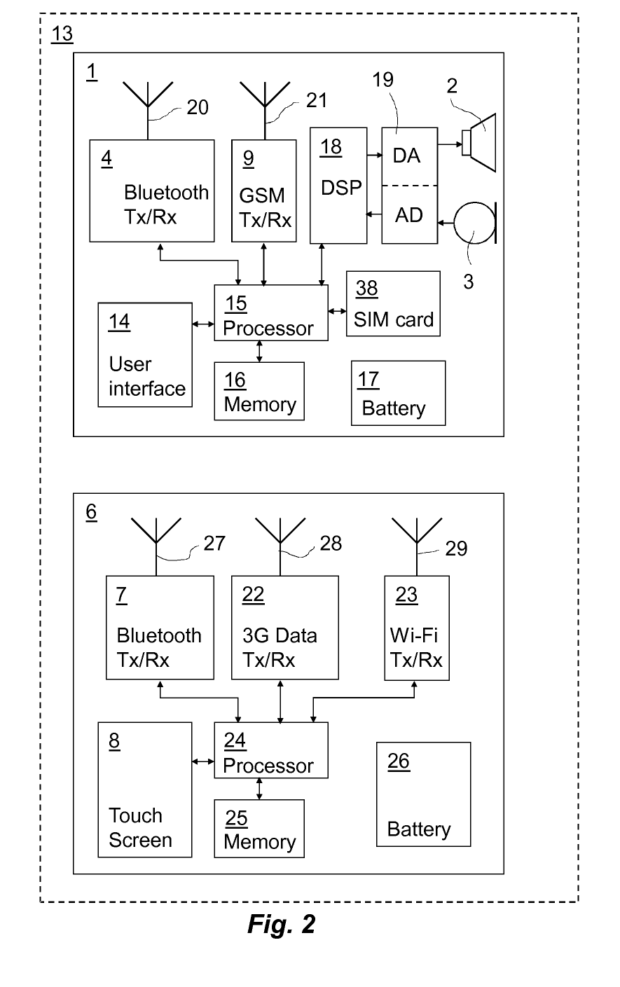

FIG. 2 discloses a headset system 13 comprising the headset 1 and the tablet computer 2 shown in FIG. 1. Only the most relevant parts for explaining the disclosure are disclosed in FIG. 2. The headset 1 comprises a user interface 14, which includes the multifunction button 14, a processor 15, a memory circuit 16, a rechargeable battery 17, a Bluetooth transceiver 4 with amplifiers, a Bluetooth antenna 20, a GSM transceiver 9 with amplifiers, a GSM antenna 21, a digital signal processor (DSP) 18, a D/A-A/D converter 19, a speaker 2, a microphone 3 and a SIM card 38. The memory circuit 16 store suitable telephony software which is necessary for making and receiving telephone calls, and the headset comprises all the necessary hardware for this purpose.

The tablet computer 6 comprises a touch screen 8, a processor 24, a memory circuit 25, a rechargeable battery 26, a Bluetooth transceiver 7 with amplifiers, a Bluetooth antenna 27, a 3G transceiver 22 with amplifiers, a 3G antenna 28, a Wi-Fi transceiver 23 with amplifiers and a Wi-Fi antenna 29. The 3G transceiver 22 is used for wireless broadband access to the Internet via the 3G network that mobile phones use. Although the tablet computer 6 comprises access to the 3G network, it may or may not provide cellular telephony. It is of course possible to use IP telephony, such as Skype, if a VoIP client is installed on the tablet computer 6.

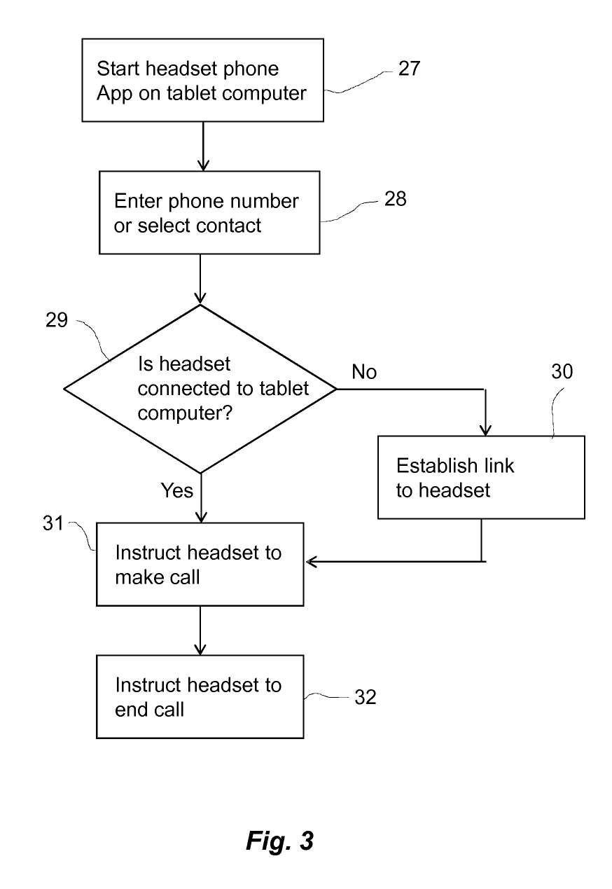

FIG. 3 discloses a method of making and ending a telephone call by means of the headset system explained above. At step 27 the headset phone app is started. At step 28 a phone number is entered or a contact is selected from a contact list or call list. At step 29 it is determined whether there is established a Bluetooth link between the headset and the tablet computer. If not, such a link is established at step 30. At step 31 the headset transfer instructions to setup a call to the headset. When the call is to be finished, an “end call” button on the touch screen of the tablet computer is touched whereby instructions to end the call is transferred via the Bluetooth link to the headset, which terminates the call.

The headset according to the disclosure may also be connected via a Bluetooth link to a normal mobile phone or smart phone and used as a conventional Bluetooth headset. This may in fact be preferred in order to save the headset battery life which may relatively limited compared to that of a mobile phone.

The headset may be used as a stand-alone device for making and receiving telephone calls. Thus, it may be provided with voice recognition, whereby the user may say the name of a contact person or say a telephone number, where after the headset initiates the call. The headset may also be provided with a small display which can show contact person names and/or telephone numbers or it may be displayed on a user device, such as a tablet or Google Glass® eyewear, a wearable computer with an optical head-mounted heads up display viewable by the wearer as part of the eyewear, so that the user needs to remove the headset to see the display. Likewise, there may be an intermediary 3g/LTE/cellular interface device which could be worn by the user which contains circuits to connect the headset to a telephone network via this intermediary device, which has higher battery capacity.

It may also be possible to enable seamless call transferring between a mobile phone or smart phone and the headset according to the disclosure. Let us say, that a user makes a call by means of a smart phone and is using the headset according to the disclosure as a traditional headset. If the mobile phone runs out of battery or the headset comes out of range such that the short-range connection is lost, the call may be transferred seamlessly to the headset. It could also be contemplated, that a call is initiated directly from the headset and is transferred to the smart phone if the headset runs low on battery. Therefore, the disclosure includes a method of handing off communications between devices if either device (headset or cellphone) indicates a low battery condition.

The headset according to the disclosure may also be suitable for use in a car as an extra phone. Thus, the headset may be connected via its short-range transceiver to the car radio or GPS device whereby the displays and other user interfaces of these devices can be used for call handling.

Anyway, a very great advantage of the headset according to the disclosure is the use of it in connection with a tablet computer, such as an iPad® 2, HTC® Flyer, Motorola Zoom®, which is not able to make cellular phone calls. A travelling person often carries with him a computer, a phone and a headset. He may now only bring along a tablet computer and a headset according to the disclosure. Previously, it was assumed that the headset would be unable to initiate cellular/mobile or VIOP calls, but the present disclosure overcomes that limitation/assumption. The tablet or other interface device provides the display that is generally lacking in a headset, and the headset incorporates mobile communication technology, which as heretofore only found in phones. When staying in a hotel room he may utilize the convenience of the tablet computer to manage/initiate telephone calls from the tablet screen or call list obtained from the headset. Once the call is initiated, the tablet is superfluous to the communication. The user can leave the hotel room in the middle of a call without the tablet computer, as this call does not go through this. He may end the call later by pressing the multifunction button on the headset.

Above is shown a compact monaural headset with an ear hook, but other embodiments could be used, such as stereo headsets with a headband or a neckband interconnecting two earphones.

The short-range transceiver does not necessarily have to be a Bluetooth transceiver and the long-range transceiver does not have to be a GSM transceiver.

The disclosure is not limited to the embodiments shown here.

List of reference signs

| | |
|---|---|
| 1 | headset |
| 2 | headset speaker |
| 3 | headset microphone |
| 4 | headset Bluetooth transceiver |
| 5 | Bluetooth link |
| 6 | tablet computer |
| 7 | Bluetooth transceiver of tablet computer |
| 8 | touch screen |
| 9 | GSM transceiver |
| 10 | GSM link |
| 11 | Base Transceiver Station |
| 12 | ear hook |
| 13 | headset system |
| 14 | headset button |
| 15 | headset processor |
| 16 | headset memory circuit |
| 17 | headset battery |
| 18 | DSP (digital signal processor) of headset |
| 19 | A/D-D/A converter |
| 20 | Bluetooth antenna |
| 21 | GSM antenna of tablet computer |
| 22 | 3G transceiver of tablet computer |
| 23 | Wi-Fi transceiver of tablet computer |
| 24 | processor of tablet computer |
| 25 | memory circuit of tablet computer |
| 26 | battery of tablet computer |
| 27-32 | method steps |
| 33 | button on tablet computer |
| 34 | Base Transceiver Station tower |
| 35 | keypad |
| 36 | call button |
| 37 | window showing number to be dialled |
| 38 | SIM card |

1. A headset for wireless telecommunication comprising:
a speaker,
a microphone,
a short-range transceiver for establishing a short-range wireless link to a peripheral electronic device comprising a corresponding short-range transceiver and a user interface,
a long-range transceiver for establishing a long-range wireless link to a Base Transceiver Station in a cellular network, whereby the headset is able to make telephone calls,
and wherein the headset is adapted to receive instructions from the peripheral electronic device via the short-range transceiver to initiate cellular telephone calls.

2. A headset according to claim 1, wherein the instructions received from the peripheral electronic device includes the identity, such as the phone number, of the party to be called.

3. A headset according to claim 1, wherein the headset is adapted to receive telephone calls.

4. A headset according to claim 1, wherein the long-range transceiver is located within the headset and is configured to connect with cell towers.

5. A headset according to claim 1, wherein the short-range transceiver is a Bluetooth transceiver or a Wi-Fi transceiver.

6. A headset according to claim 1, wherein the headset is further adapted to connect to a mobile phone via the short-range transceiver.

7. A headset according to claim 1, wherein the headset is adapted for transmitting and receiving voice signals via the short-range transceiver.

8. A headset according to claim 1, which is a monaural headset with means for attaching it in front of an ear of a user or a stereo headset with a headband or a neckband interconnecting two earphones.

9. A headset according to claim 1, wherein the headset comprising the speaker, the microphone, the short-range transceiver and the long-range transceiver is configured to be worn at the head of a user and/or attached to at least one ear of a user.

10. A headset (1) according to claim 1, wherein the headset comprises voice recognition.

11. A headset system comprising a headset according to claim 1, wherein the peripheral electronic device comprising a short-range transceiver corresponding to the short-range transceiver of the headset and a user interface.

12. A headset system according to claim 11, wherein the peripheral electronic device is configured to manage outgoing and incoming phone calls from and to the headset.

13. A headset system according to claim 11, wherein the peripheral electronic device comprises a display.

14. A headset system according to claim 13, wherein the display is configured to display a contact list, a call list and/or a phone number.

15. A headset system according to claim 11, wherein the peripheral electronic device is a tablet computer.

16. The headset system of claim 1, wherein said headset includes a low battery sensor and wherein a phone call in progress is transferable to another device in a low battery condition.

17. A method of initiating a phone call from a headset containing a short range transmitter to a display input device and a long range transmitter to a cellular tower comprising the steps of downloading a telephone dial list to said input device, selecting a number from said list at said input device, transmitting the number, via said short range transmitter, to said headset, having the headset initiate a cellular call therefrom, and decoupling said input device, if the headset is moved out of range, without dropping the call.

18. The method of claim 17, wherein said input device is a wearable computer with an optical head-mounted display.

19. A headset for wireless telecommunication comprising:
a speaker,
a microphone,
a housing incorporated with said housing is a short-range transceiver for establishing a short-range wireless link to a peripheral electronic device comprising a corresponding short-range transceiver and a user interface,
a long-range transceiver for establishing a long-range wireless link to a Base Transceiver Station in a cellular network, whereby the headset is able to make telephone calls,
and wherein the headset includes a data table of phone numbers, and is adapted to transmit said data table to said peripheral device and receive dialing instructions from the peripheral electronic device via the short-range transceiver to initiate cellular telephone calls, whereupon said peripheral device is superfluous to the initiated call.
